(19) United States
(12) Patent Application Publication
(10) Pub. No.: US 2016/0154935 A1
(43) Pub. Date: Jun. 2, 2016

(54) WEB RESOURCE ACCESSING AND PROCESSING METHOD

(71) Applicant: Infinitt Healthcare Co., Ltd., Seoul (KR)

(72) Inventors: Jung Bin KIM, Seoul (KR); Kyu Jin CHOI, Seoul (KR); Yong Seok KIM, Yongin-si (KR)

(21) Appl. No.: 14/603,370

(22) Filed: Jan. 23, 2015

(30) Foreign Application Priority Data
Nov. 29, 2014 (KR) 10-2014-0169244
Jan. 21, 2015 (KR) 10-2015-0010209

(51) Int. Cl. G06F 19/00

(52) U.S. Cl. CPC G06F 19/322; G06F 19/321

(57) ABSTRACT

A web resource accessing and processing method is a method of allowing an authenticated client terminal to access a vendor neutral archive (VNA), wherein the web resource includes patient information, document information, and image information, the client terminal includes a memory, and the memory includes a patient information memory section in which the patient information of the web resource is stored, a document information section in which the document information of the web resource is stored, and an image information memory section in which the image information of the web resource is stored.

### CROSS-REFERENCE TO RELATED APPLICATION

This application claims priority to and the benefit of Korean Patent Application No. 10-2014-0169244 filed on Nov. 29, 2014, and Korean Patent Application No. 10-2015-0010209 filed on Jan. 21, 2015, the disclosures of which are incorporated by reference herein in their entireties.

### BACKGROUND

1. Technical Field

The present invention relates to a web resource accessing and processing method, and more particularly, to a web resource accessing and processing method that can allow simultaneous use of http-based RESTful services of different standards, that can solve a problem that rights to access web resources are not uniform, that can extend XDS metadata so as to make a search with conditions corresponding to a request from a client terminal even when general-purpose XDS techniques other than techniques dedicated to search tor medical images are used, and that can directly access binary data representing image information without making a search from the beginning of the image information when searching the image information.

2. Discussion of Related Art

In the related art, in order to remotely search for DICOM (medical image standard) images, there is information to be preferentially acquired from a patient ID database or the like. Alternatively, in order to remotely search for DICOM images, it is necessary to preferentially acquire unique IDs such as StudyInstanceUID, SeriesInstanceUID, and SOPInstanceUID of DICOM images.

When current XDS techniques are used to search for medical images, there are problems in that processes for inquiring about or searching a document list are complicated and structural information thereof has to be processed using different protocols. It is possible to simplify XDS usage using MHD techniques, but information connectivity is insufficient. In addition, there is a problem in that rights to access web resources are not uniform.

Meanwhile, XDS metadata in the related art is defined by information provided from the IHE, but there is a problem in that it is difficult to search for other information. This is because the XDS is not developed for a special purpose of searching for medical images, but is a general-purpose protocol. Information provided from the IHE is information, which it is difficult for a user to know or has a low importance as search objects, such as language code and format code but information relevant to information provided from a medical information system, such as accession numbers and order numbers, which are often used by a user, is not provided. As a result, user convenience is not considered at all. Accordingly, it is necessary to register extended metadata when registering an XDS document, which has not been considered as a problem in the field of medical images.

In the related art, bulk data has to be acquired in a REST manner when inquiring about medical information using a DICOM web, a unique key to the bulk data has to be issued, and the bulk data has to be returned on the basis thereof. At this time, the method of acquiring the bulk data corresponding to a unique key has to be optimized and has to cope with a varying DICOM structure, but the standard does not provide an algorithm for coping with such a situation. Accordingly, when a client terminal access DICOM images in the related art, it is preferable that the client terminal directly access binary data representing image information from the viewpoint of providing services without any time delay. However, there is a problem in the related art in that the binary data cannot be accessed but is searched from the beginning part.

### SUMMARY

The present invention is directed to a web resource accessing and processing method that can allow simultaneous use of http-based RESTful services of different standards, that can solve a problem in which rights to access web resources are not uniform, that can extend XDS metadata so as to make a search with conditions corresponding to a request from a client terminal even when general-purpose XDS techniques other than techniques dedicated to search for medical images are used, and that can directly access binary data representing image information without making a search from the beginning of the image information when searching for the image information.

According to an aspect of the present invention, there is provided a web resource accessing and processing method of allowing an authenticated client terminal to access a vendor neutral archive (VNA), wherein the web resource includes patient information, document information, and image information, the client terminal includes a memory, and the memory includes a patient information memory section in which the patient information of the web resource is stored, a document information section in which the document information of the web resource is stored, and an image information memory section in which the image information of the web resource is stored.

The web resource accessing and processing method may include: an authentication level classifying step of classifying an authentication level of the client terminal into a first authentication level at which the client terminal is able to access the patient information of the web resource, a second authentication level at which the client terminal is able to access the patient information and the document information of the web resource, and a third authentication level at which the client terminal is able to access the patient information, the document information, and the image information of the web resource; and an authentication level allocating step of allocating one of the first authentication level, the second authentication level, and the third authentication level to the client terminal.

The client terminal may sequentially access the patient information, the document information, and the image information of the web resource and stores the accessed information in the memory of the client terminal.

The client terminal may store the patient information of the web resource in the memory of the client terminal when the first authentication level is allocated to the client terminal, the client terminal may sequentially access the patient information and the document information of the web resource and may store the accessed information in the memory of the client terminal when the second authentication level is allocated to the client terminal, and the client terminal may sequentially access the patient information, the document information, and the image information of the web resource and may store the accessed information in the memory of the client terminal when the third authentication level is allocated to the client terminal.

The patient information stored in the patient information memory section may include information of a patient, who is selected by the client terminal, in a patient list, the document information stored in the document information memory section may include a medical document of the selected patient and an image list of the selected patient, and the image information stored in the image information memory section may include images corresponding to the image list.

The client terminal may access the patient information of the web resource using an HL7 FHIR, the client terminal may access the document information of the web resource using an IHE MHD, and the client terminal may access the image information of the web resource using a DICOM Web.

The document information may include XDS metadata, the XDS metadata may include an item of EventCodeList, and the web resource may be uploaded through an XDS metadata extending step of adding other-system-interlocked reference numbers to the item of EventCodeList.

Each other-system-interlocked reference number may include one or more of an order number (order No.), an authorization number (authorization No.), a request procedure ID, an accession number (accession No.), a billing number (billing No.), and an account number (account No.).

When the client terminal accesses the web resource, the client terminal may search for information using one or more of the other-system-interlocked reference numbers and may store the searched-for information in the document information memory section of the client terminal.

Meanwhile, the image information may include a unique key (uuid), the unique key may represent a piece of binary data in a DICOM file which is the image information and may have offset information of the binary data, which is position information of actual image information in a file structure of the image information, as a reference point, a server connected to the client terminal may include the unique key and a mapping table between binary data as actual image information, and the client terminal may access the actual image information with reference to the unique key and the mapping table.

The web resource accessing and processing method may further include a step of directly accessing the actual image information with reference to the unique key and the mapping table and storing the accessed actual image information in the image information memory section when the client terminal accesses the image information.

The web resource accessing and processing method may further include a step of adjusting the reference point of the mapping table when a position of an original file of the image information is changed, the original file of the image information is corrected, or the original file of the image information is deleted.

By employing the web resource accessing and processing method according to the present invention, first, it is possible to use http-based RESTful services of different standards together.

Second, it is possible to solve a problem in which rights to access web resources relevant to medical images, in which secrecy and security of personal information are very important are not uniform.

Third, it is possible to extend XDS metadata so as to make a search with conditions corresponding to a request from a client terminal even when general-purpose XDS techniques other than techniques dedicated to search for medical images are used.

Fourth, it is possible to directly access binary data representing image information without making a search from the beginning of the image information when remotely searching the image information.

### BRIEF DESCRIPTION OF THE DRAWINGS

The above and other objects, features and advantages of the present invention will become more apparent to those of ordinary skill, in the art by describing in detail exemplary embodiments thereof with reference to the accompanying drawings, in which:

FIG. 1 is a diagram illustrating the entire configuration of a system that performs a web resource accessing and processing method according to an exemplary embodiment of the present invention;

FIG. 2 is a flowchart illustrating process steps of the web resource accessing and processing method according to the exemplary embodiment of the present invention;

FIG. 3 is a flowchart illustrating details of an XDS metadata extending step in the web resource accessing and processing method according to the exemplary embodiment of the present invention;

FIG. 4 is a diagram illustrating an example in which an item of EventCodeList in XDS metadata is extended;

FIG. 5 is a flowchart illustrating more details of the XDS metadata extending step in the web resource accessing and processing method according to the exemplary embodiment of the present invention;

FIG. 6 is a diagram illustrating an example of the XDS metadata extending step in the web resource accessing and processing method according to the exemplary embodiment of the present invention, in which an accession number (accession No.) is added for document registration;

FIG. 7 is a diagram illustrating an example in which an accession number (accession No.) is used for document search after the XDS metadata extending step in the web resource accessing and processing method according to the exemplary embodiment of the present invention; and

FIG. 8 is a diagram illustrating a method of allowing direct access to binary data representing image information without making a search from the beginning part of the image information when remotely searching image information using a unique key and a mapping table.

### DETAILED DESCRIPTION OF EXEMPLARY EMBODIMENTS

Exemplary embodiments of the present invention will be described in detail below with reference to the accompanying drawings. Terminology or words used in this description or the appended claims should not be analyzed to have general or colloquial meanings, but should be analyzed to have meanings and concepts corresponding to the technical spirit of the present invention, on the basis of the principle that an inventor can appropriately define concepts of terms for the purpose of explaining the present invention in a best mode.

Therefore, embodiments described in this description and the configurations illustrated in the drawings are merely best exemplary embodiments of the present invention and do not represent all the technical spirit of the present invention. Accordingly, it should be understood by those skilled in the art that there may be various equivalents and modifications with which the exemplary embodiments can be replaced at the time of filing of the present invention.

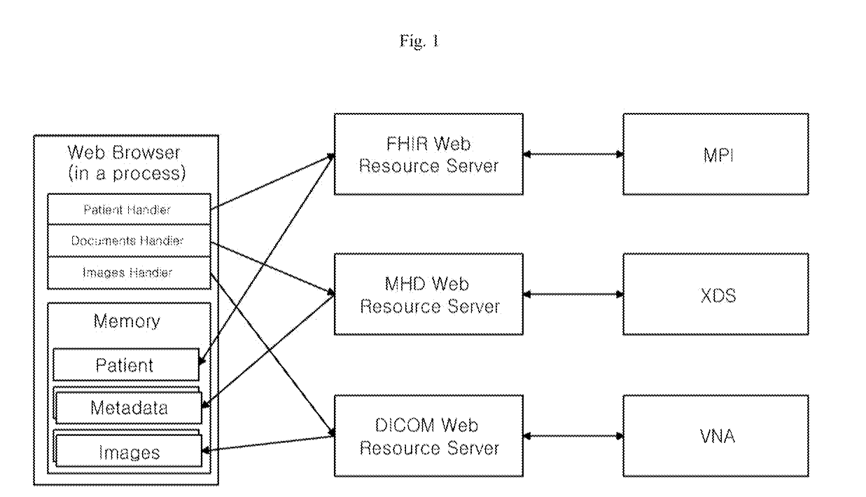

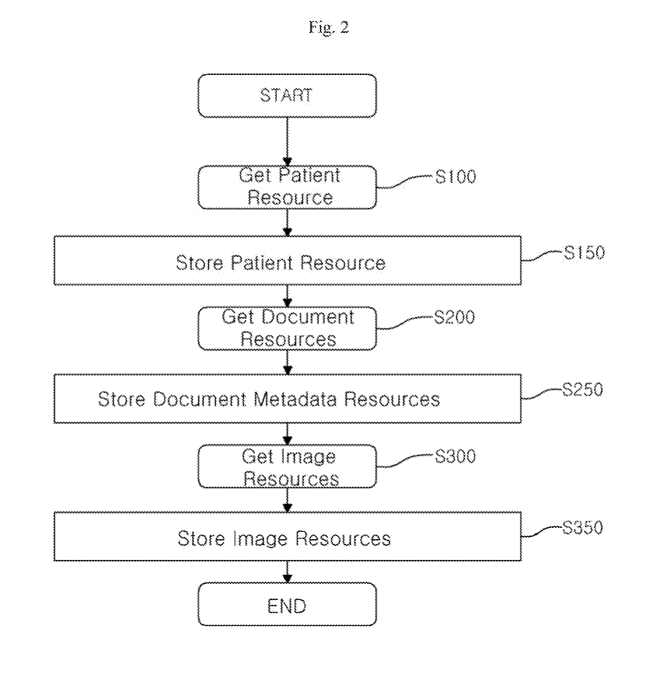

FIG. 1 is a diagram illustrating the entire configuration of a system that performs a web resource accessing and processing method according to an exemplary embodiment of the present invention. FIG. 2 is a flowchart illustrating process steps of the web resource accessing and processing method according to the exemplary embodiment of the present invention.

As illustrated in FIG. 1, the present invention provides a method of allowing an authenticated client terminal to access a vendor neutral archive (VNA) and to access and process a web resource. Here, the web resource includes patient information, document information, and image information, the client terminal includes a memory having a patient information memory section in which the patient information is stored, a document information section in which the document information is stored, and an image information memory section in which the image information is stored.

OpenAuth may be used to give a right to access a web resource depending on a client terminal having a web browser. A scope field may be defined using OpenAuth and a minimum level for accessing the respective information pieces may be set. Specifically, the method includes: an authentication level classifying step of classifying an authentication level of the client terminal into a first authentication level at which the client terminal is able to access the patient information, a second authentication level at which the client terminal is able to access the patient information and the document information, and a third authentication level at which the client terminal is able to access the patient information, the document information, and the image information; and an authentication level allocating step of allocating one of the first authentication level, the second authentication level, and the third authentication level to the client terminal. Accordingly, it is possible to solve a problem in which rights to access web resources relevant to medical images, in which secrecy and security of personal information are very important, are not uniform.

As illustrated in FIGS. 1 and 2, the client terminal may sequentially access the patient information, the document information, and the image information of the web resource (S100, S200, and S300), may store the accessed information in the memory of the client terminal (S150, S250, and S350), and may rapidly acquire information needed by the web browser of the client terminal.

By interlocking with the aforementioned authentication levels, the client terminal may store the patient information in the memory of the client terminal when the first authentication level is allocated to the client terminal, the client terminal may sequentially access the patient information and the document information and may store the accessed information in the memory of the client terminal when the second authentication level is allocated to the client terminal, and the client terminal may sequentially access the patient information, the document information, and the image information and may store the accessed information in the memory of the client terminal when the third authentication level is allocated to the client terminal.

Here, the patient information stored in the patient information memory section includes information of a patient, who is selected by the client terminal, in a patient list of a master patient index (MPI), the document information stored in the document information memory section includes a medical document of the selected patient and an image list of the selected patient, and the image information stored in the image information memory section includes images corresponding to the image list. The MPI represents an electronic database including names, contact information, and medical information of patients registered in a medical facility. The image information includes binary data (or bulk data).

At this time, the client terminal accesses the patient information of the MPI using an HL7 FHIR or an HL7 FHIR.Patient (JSON), the client terminal accesses the document information using an IHE MHD or an IHE MHD document dossier (JSON). and the client terminal accesses the image information using a DICOM Web or a DICOM WADO RS (JSON, bulk data). Accordingly, the client terminal acquires DICOM images from the VNA.

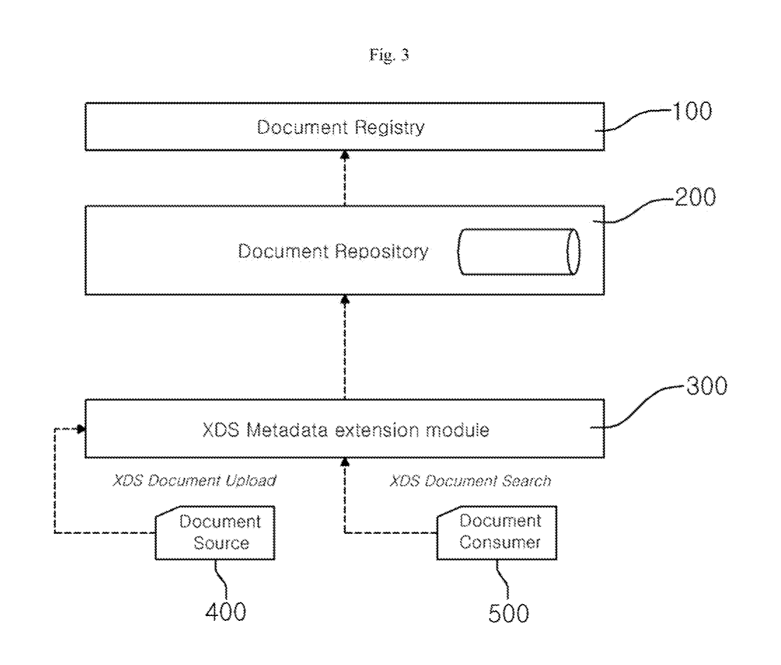

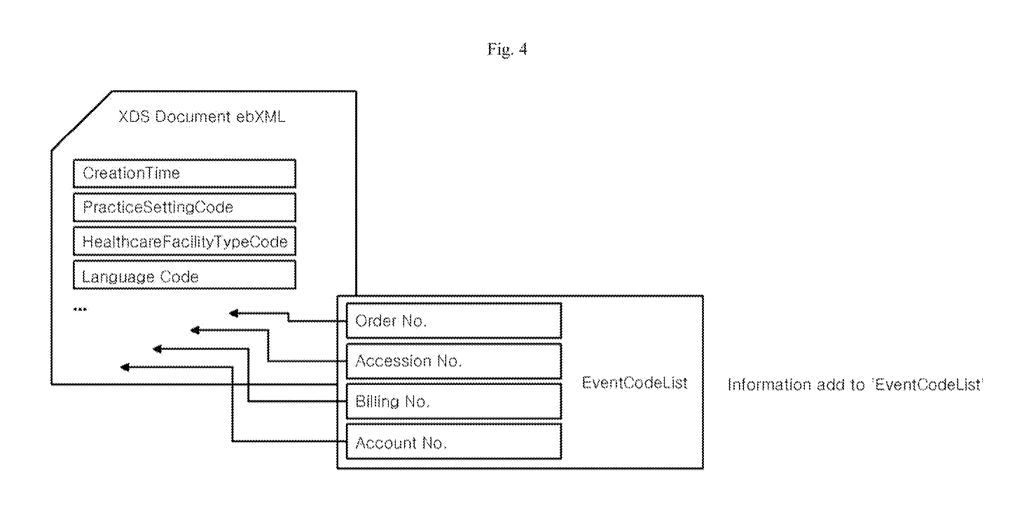

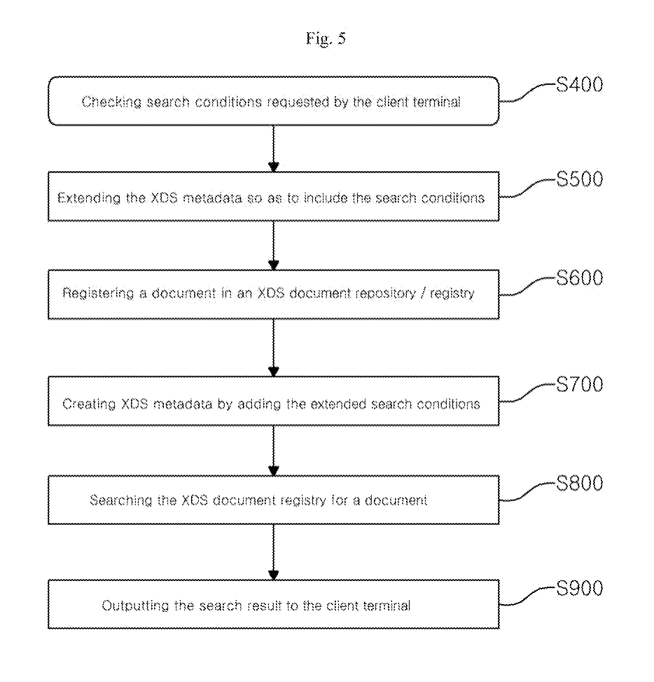

FIG. 3 is a flowchart illustrating details of an XDS metadata extending step in the web resource accessing and processing method according to the exemplary embodiment of the present invention. FIG. 4 is a diagram illustrating an example in which an item of EventCodeList in XDS metadata is extended. FIG. 5 is a flowchart illustrating more details of the XDS metadata extending step in the web resource accessing and processing method according to the exemplary embodiment of the present invention.

As illustrated in FIGS. 3 and 5, in the present invention, the XDS metadata is configured to he extendable so as to make a search with conditions corresponding to a request from the client terminal. That is, the XDS metadata is extended in classification elements which can be arbitrarily defined in the item of EventCodeList. Each classification includes a code scheme (slot value) and a code (NodeRepresentation). The code scheme employs an item name, and the defined code scheme does not receive validation from the registry. A search may be made in consideration of a classification element which is arbitrarily defined by FindDocument in stored queries in the registry. The code scheme which can be arbitrarily defined may include image information or other-system-interlocked reference numbers (information generated by a medical information system, such as an accession number and an order number). The XDS metadata is expressed in a document dossier by the IHE MHD.

Referring to FIG. 5 again, the XDS metadata extending step includes a step (S400) of checking search conditions requested by the client terminal, a step (S500) of extending the XDS metadata so as to include the search conditions, a step (S600) of registering a document in an XDS document repository/registry, a step (S700) of creating XDS metadata by adding the extended search conditions thereto, a step (S800) of searching the XDS document registry for a document, and a step (S900) of outputting the search result to the client terminal.

Accordingly, when the client terminal accesses web resources, the client terminal may search the web resources using one or more of the other-system-interlocked reference numbers. The searched information is stored in the document information memory section of the client terminal.

For reference, an order number (order No.), an authorization number (Auth No.), a request ID, an accession number (accession No.), a billing number (billing No.), and an account number (account No.) which are the other-system-interlocked reference numbers will be described below.

The accession number (accession No.) is a unit for binding medical activities, from the time point at which an imaging request is generated from, an order up to a step of execution (acquisition, treatment), using a specific purpose. The accession number is generated from an HIS/EMR and is used as a number representing the order issued from the HIS/EMR.

The account number (account No.) is a unit for binding a series of processes, from the time point at which a patient visits a hospital to the time point at which the patient leaves the hospital after being subjected to all necessary medical services, for the purpose of payment. The account number may be used to issue a receipt number which is generated when the patient enters or visits the hospital.

The order number (order No.) is a number representing a group of requests for medical activities such as treatment, prescription, and examination for a specific purpose in reality. An example of the group of requests is as follows. When different departmental processes and issuance of different reports are required as in a medical examination, different requests for the medical examination as a specific purpose are issued using a single order. The order number may be treated in the same way as the accession number.

The requested procedure ID is a unique value given when a requested procedure is issued, and this value is delivered to the lowest stage such as equipment. The requested procedure ID is issued from an order filler system, which means that imaging, examination, and the like are executed for the same purpose. The requested procedure ID is important because the value thereof serves as a core value in connection to other systems. The accession number is used tor order placer-order filler connection, but this value is used for intermediate connections such as order filler-examination instrument (modality), order filler-PACS, and order filler-result creator (report).

The authorization number (authorization No.) means a number relevant to a radiologist or imaging permission of an insurance company for an imaging target when radiography is requested.

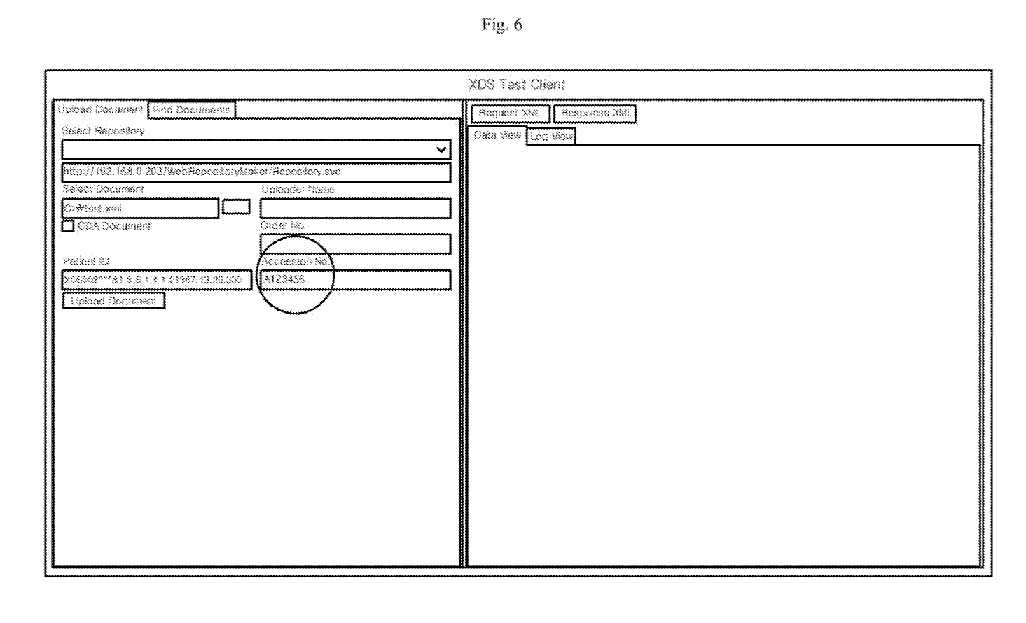

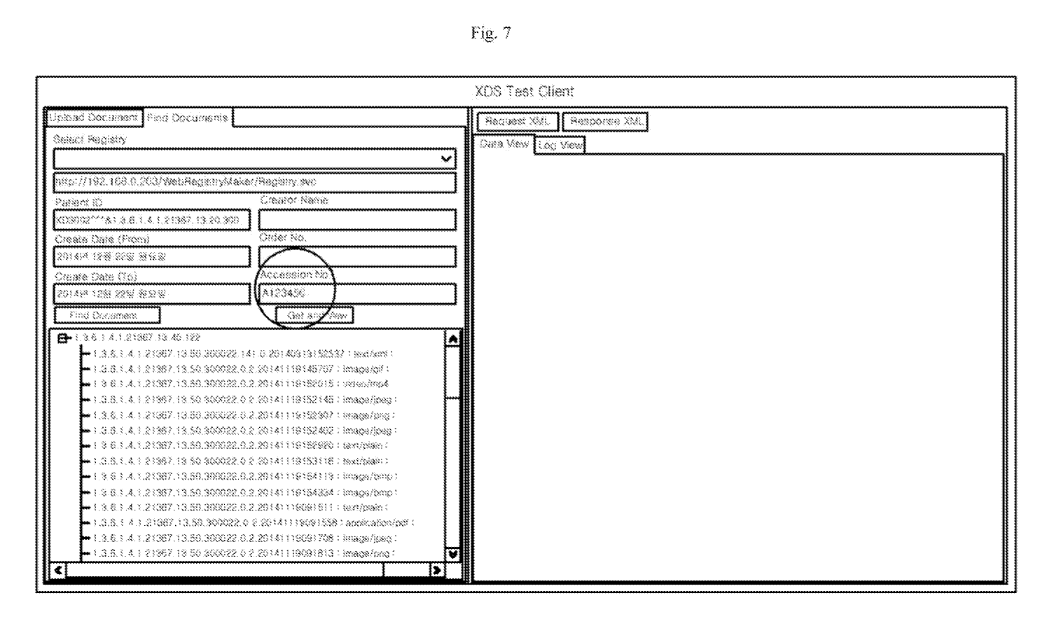

FIG. 6 is a diagram illustrating an example of the XDS metadata extending step in the web resource accessing and processing method according to the exemplary embodiment of the present invention, in which an accession number (accession No.) is added for document registration. FIG. 7 is a diagram illustrating an example in which an accession number (accession No.) is used for a document search after the XDS metadata extending step in the web resource accessing and processing method according to the exemplary embodiment of the present invention.

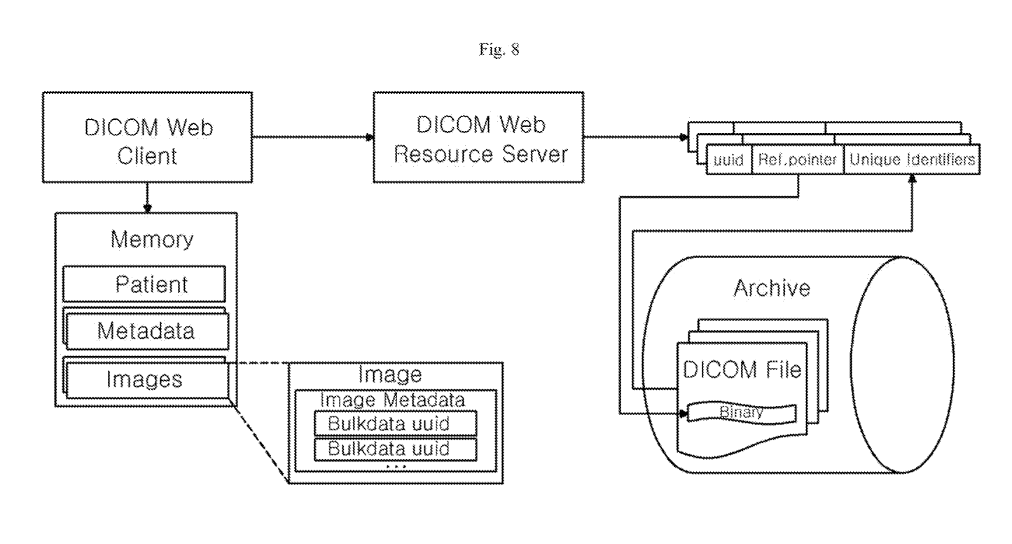

FIG. 8 is a diagram illustrating a method of allowing direct access to binary data representing image information without making a search from the beginning part of the image information when remotely searching for image information using a unique key and a mapping table.

According to the present invention, the image information includes a unique key (uuid), the unique key represents a piece of binary data in a DICOM file which is the image information and has offset information of the binary data, which is position information of actual image information in a file structure of the image information, as a reference point, a server connected to the client terminal includes the unique key and a mapping table between binary data as actual image information, and the client terminal may access the actual image information with reference to the unique key and the mapping table. Accordingly, a useless inquiry time due to an inquiry from the beginning part of the image information is not required.

Here, items included in the mapping table are the unique key, reference points indicating reference positions in an original image file and offset positions of binary data in the original file, and unique IDs (one or more of Study Instance UID, Series Instance UID, and SOP Instance UID) in the original file.

The web resource accessing and processing method may further include a step of directly accessing the actual image information with reference to the unique key and the mapping table and storing the accessed actual image information in the image information memory section when the client terminal accesses the image information.

The web resource accessing and processing method may further include a step of adjusting the reference point of the mapping table when a position of an original file of the image information is changed, the original file of the image information is corrected, or the original file of the image information is deleted.

What is claimed is:

1. A web resource accessing and processing method of allowing an authenticated client terminal to access a vendor neutral archive (VNA),
wherein the web resource includes patient information, document information, and image information,
wherein the client terminal includes a memory, and
wherein the memory includes a patient information memory section in which the patient information of the web resource is stored, a document information section in which the document information of the web resource is stored, and an image information memory section in which the image information of the web resource is stored.

2. The web resource accessing and processing method according to claim 1, comprising:
an authentication level classifying step of classifying an authentication level of the client terminal into a first authentication level at which the client terminal is able to access the patient information of the web resource, a second authentication level at which the client terminal is able to access the patient information and the document information of the web resource, and a third authentication level at which the client terminal is able to access the patient information, the document information, and the image information of the web resource; and
an authentication level allocating step of allocating one of the first authentication level the second authentication level and the third authentication level to the client terminal.

3. The web resource accessing and processing method according to claim 1, wherein the client terminal sequentially accesses the patient information, the document information, and the image information of the web resource and stores the accessed information in the memory of the client terminal.

4. The web resource accessing and processing method according to claim 2, wherein the client terminal stores the patient information of the web resource in the memory of the client terminal when the first authentication level is allocated to the client terminal,
wherein the client terminal sequentially accesses the patient information and the document information of the web resource and stores the accessed information in the memory of the client terminal when the second authentication level is allocated to the client terminal, and
wherein the client terminal sequentially accesses the patient information, the document information, and the image information of the web resource and stores the accessed information in the memory of the client terminal when the third authentication level is allocated to the client terminal.

5. The web resource accessing and processing method according to claim 1, wherein the patient information stored in the patient information memory section includes information of a patient, who is selected by the client terminal, in a patient list,
wherein the document information stored in the document information memory section includes a medical document of the selected patient and an image list of the selected patient, and
wherein the image information stored in the image information memory section includes images corresponding to the image list.

6. The web resource accessing and processing method according to claim 1, wherein the client terminal accesses the patient information of the web resource using an HL7 FHIR,
wherein the client terminal accesses the document information of the web resource using an IHE MHD, and
wherein the client terminal accesses the image information of the web resource using a DICOM Web.

7. The web resource accessing and processing method according to claim 1, wherein the document information includes XDS metadata,
wherein the XDS metadata includes an item of EventCodeList, and
wherein the web resource is uploaded through an XDS metadata extending step of adding other-system-interlocked reference numbers to the item of EventCodeList.

8. The web resource accessing and processing method according to claim 7, wherein each other-system-interlocked reference number includes one or more of an order number (order No.), an authorization number (authorization No.), a request procedure ID, an accession number (accession No.), a billing number (billing No.), and an account number (account No.).

9. The web resource accessing and processing method according to claim 7, wherein when the client terminal accesses the web resource, the client terminal searches for information using one or more of the other-system-interlocked reference numbers and stores the searched-for information in the document information memory section of the client terminal.

10. The web resource accessing and processing method according to claim 9, wherein each other-system-interlocked reference number includes one or more of an order number (order No.), an authorization number (authorization No.), a request procedure ID, an accession number (accession No.), a billing number (billing No.), and an account number (account No.).

11. The web resource accessing and processing method according to claim 1, wherein the image information includes a unique key (uuid),
wherein the unique key represents a piece of binary data in a DICOM file which is the image information and has offset information of the binary data, which is position information of actual image information in a file structure of the image information, as a reference point,
wherein a server connected to the client terminal includes the unique key and a mapping table between binary data as actual image information, and
wherein the client terminal accesses the actual image information with reference to the unique key and the mapping table.

12. The web resource accessing and processing method according to claim 11, further comprising a step of directly accessing the actual image information with reference to the unique key and the mapping table and storing the accessed actual image information in the image information memory section when the client terminal accesses the image information.

13. The web resource accessing and processing method according to claim 12, further comprising a step of adjusting the reference point of the mapping table when a position of an original file of the image information is changed, the original file of the image in formation is corrected, or the original file of the image information is deleted.
